(19) United States
(12) Patent Application Publication
(10) Pub. No.: US 2011/0248982 A1
(43) Pub. Date: Oct. 13, 2011

(54) SOURCE DRIVER AND DISPLAY APPARATUS AND METHOD FOR DRIVNG A DISPLAY PANEL

(75) Inventor: MENG-WEI CHUANG, Miaoli (TW)

(73) Assignee: FITIPOWER INTEGRATED TECHNOLOGY, INC., Miaoli County (TW)

(21) Appl. No.: 12/910,810

(22) Filed: Oct. 24, 2010

(30) Foreign Application Priority Data
Apr. 7, 2010 (TW) 99110810

(51) Int. Cl. G09G 3/36; G09G 5/00

(52) U.S. Cl. 345/212; 345/100

(57) ABSTRACT

A source driver includes a shift register, a latch, a digital to analog converter (DAC), an output buffer, a level shifter, and a comparator. The shift register receives digital image data. The latch stores digital image data under control of the shift register. The DAC is coupled to the latch and converts digital image data to analog image data. The level shifter shifts a voltage level of analog image data, generates a number of first driving voltages, and outputs the first driving voltages to the output buffer. The comparator controls a voltage generator to generate a number of second driving voltages between corresponding two neighboring first driving voltages; and the voltage generator outputs the second driving voltages to the output buffer. The output buffer sequentially outputs the first driving voltages and the second driving voltages.

### BACKGROUND

1. Technical Field

The disclosed embodiments relate to source drivers, and more particularly to a source driver for a liquid crystal display (LCD).

2. Description of Related Art

A source driver is commonly used for sequentially providing a number of driving voltages to a liquid crystal display (LCD) panel, to drive the LCD panel to display images. Sometimes, a voltage difference between two neighboring driving voltages is greater than a reference value, and thus may damage the LCD panel.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout three views.

FIG. 1 is a block diagram showing a display apparatus in accordance with an exemplary embodiment, the display apparatus includes a source driver and a display panel.

FIG. 2 is a graphical representation showing a number of driving voltages generated by the source driver of FIG. 1.

FIG. 3 is a flow chart illustrating a method for driving a display panel in accordance with an exemplary embodiment.

### DETAILED DESCRIPTION

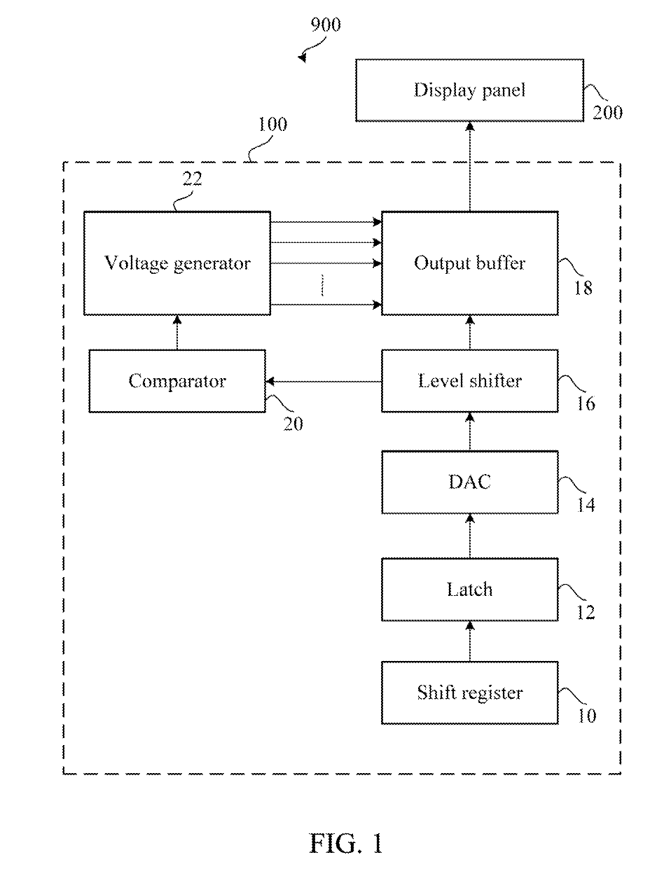

Referring to FIG. 1, a display apparatus 900 includes a source driver 100 and a display panel 200. The source driver 100 is used for providing a number of driving voltages to the display panel 200, to drive the display panel 200 to display images. In this embodiment, the display panel 200 is a liquid crystal display (LCD) panel.

The source driver 100 includes a shift register 10, a latch 12, a digital to analog converter (DAC) 14, a level shifter 16, an output buffer 18, a comparator 20, and a voltage generator 22.

The shift register 10 is used for receiving digital image data, the digital image data includes image data of sequentially arranged horizontal lines. When the shift register 10 completely receives the digital image data of one horizontal line, the shift register 10 generates a control signal.

The latch 12 is used for storing the digital image data of one horizontal line according to the control signal.

The DAC 14 is coupled to the latch 12 and is used for converting digital image data to analog image data.

The level shifter 16 is used for shifting a voltage level of analog image data, generating a number of first driving voltages V1, V2, . . . , Vn, and outputting the first driving voltages V1, V2, . . . , Vn to the output buffer 18.

The comparator 20 is used for calculating a voltage difference between each two neighboring first driving voltages, comparing the voltage difference with a reference value, controlling the voltage generator 22 to generate a number of second driving voltages according to the reference value when the voltage difference is greater than the reference value. The number of second driving voltages are between the corresponding two neighboring first driving voltages, thus the voltage difference between each two neighboring second driving voltages is less than the voltage difference between each two neighboring first driving voltages. In this embodiment, the voltage difference between each two neighboring second driving voltages is the same and less than or equal to the reference value.

The voltage generator 22 outputs the number of second driving voltages to the output buffer 18.

The output buffer 18 sequentially outputs the number of first driving voltages V1, V2, . . . , Vn and the number of second driving voltages to the display panel 200.

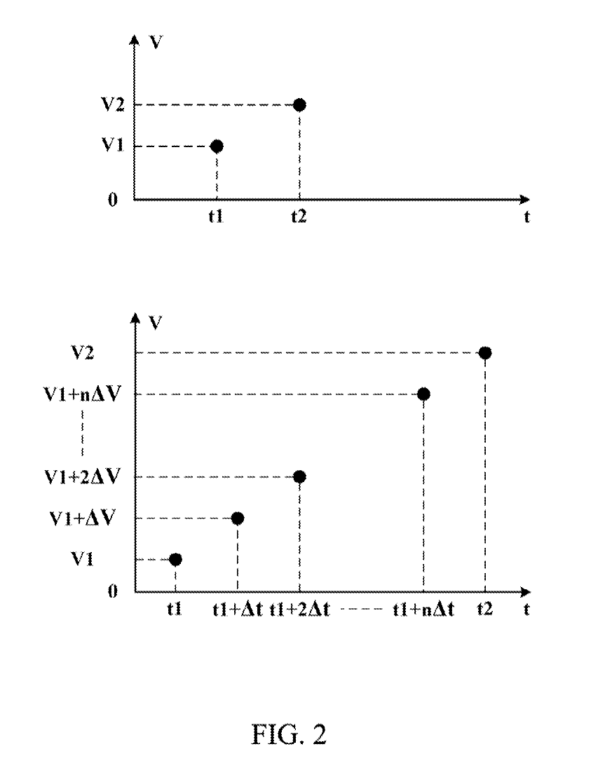

Referring to FIG. 2, if the voltage difference between the first driving voltage V1 and V2 is less than or equal to the reference value. The source driver 100 outputs the first driving voltage V1 to the display panel 200 at the time t1, and outputs the first driving voltage V2 to the display panel 200 at the time t2.

If the voltage difference between the first driving voltage V1 and V2 is greater than the reference value, the voltage generator 22 generates the number of second driving voltages V1+ΔV, V1+2ΔV, . . . , V1+nΔV, outputs the first driving voltage V1 at the time t1, then respectively outputs the second driving voltages V1+ΔV, V1+2ΔV, . . . , V1+nΔV at the time t1+Δt, t1+2Δt, . . . , t1+nΔt, and outputs the first driving voltage V2 at the time t2 to the display panel 200. It is obvious that the voltage difference between each two neighboring second driving voltages is less than the voltage difference between the first driving voltage V1 and V2, therefore the display panel 200 can be protected from being damaged by a surge in voltage.

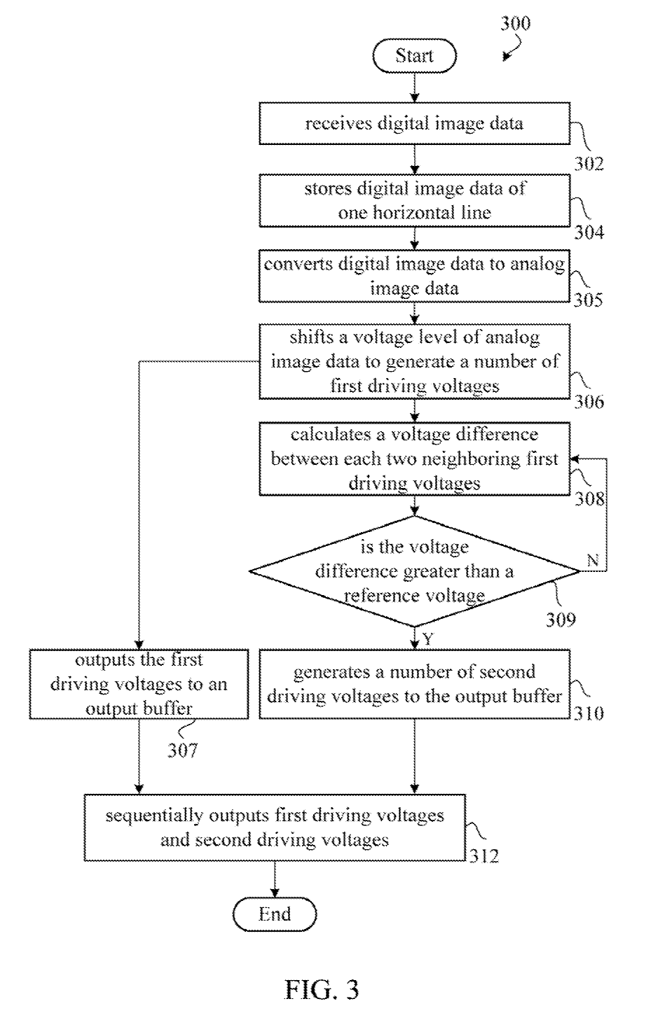

Referring to FIG. 3, a method 300 for driving a display panel 200 is illustrated. The method 300 includes following steps:

Step 302, the shift register 10 receives digital image data. The digital image data includes image data of the sequentially arranged horizontal lines. When the shift register 10 completely receives digital image data of one horizontal line, the shift register 10 generates a control signal.

Step 304, the latch 12 stores digital image data of one horizontal line according to the control signal.

Step 305, the DAC 14 converts digital image data to analog image data.

Step 306, the level shifter 16 shifts a voltage level of analog image data to generate a number of first driving voltages V1, V2, . . . , Vn.

Step 307, the level shifter 16 outputs the first driving voltages V1, V2, . . . , Vn to an output buffer 18.

Step 308, the comparator 20 calculates a voltage difference between each two neighboring first driving voltages.

Step 309, the comparator 20 determines if the voltage difference is greater than a reference value. If the difference voltage is less than or equal to the reference value, the procedure returns to step 308. If the difference voltage is greater than the reference value, step 310 is implemented.

Step 310, the comparator 20 controls the voltage generator 22 to generate a number of second driving voltages according to the reference value, and the voltage generator 22 outputs the second driving voltages to the output buffer 18. The number of second driving voltages are between corresponding two neighboring first driving voltages, the voltage difference between each two second driving voltages is less than or equal to the reference value.

Step 312, the output buffer 18 sequentially outputs the first driving voltages V1, V2, . . . , Vn and the second driving voltages to the display panel 200.

Further alternative embodiments will become apparent to those skilled in the art without departing from the spirit and scope of what is claimed. Accordingly, the present invention should be deemed not to be limited to the above detailed description, but rather only by the claims that follow and equivalents thereof.

What is claimed is:

1. A source driver for a display panel, the source driver comprising:
a shift register for receiving digital image data;
a latch for storing digital image data under control of the shift register;
a digital to analog converter (DAC) coupled to the latch for converting digital image data to analog image data;
an output buffer;
a level shifter coupled to the DAC for shifting a voltage level of analog image data, generating a number of first driving voltages, and outputting the first driving voltages to the output buffer; and
a comparator for calculating a voltage difference between each two neighboring first driving voltages, comparing the voltage difference with a reference value, and controlling a voltage generator to generate a number of second driving voltages according to the reference value when the voltage difference is greater than the reference value; and the voltage generator outputting the second driving voltages to the output buffer;
wherein the output buffer sequentially outputs the first driving voltages and the second driving voltages to the display panel.

2. The source driver as claimed in claim 1, wherein the latch sequentially receives digital image data, the digital image data comprises image data of horizontal lines, and the horizontal lines are sequentially arranged; when the shift register completely receives digital image data of one horizontal line, the shift register generates a control signal, and the latch stores digital image data of one horizontal line according to the control signal.

3. The source driver as claimed in claim 1, wherein the voltage generator is comprised in the source driver.

4. The source driver as claimed in claim 1, wherein the second driving voltages are between corresponding two neighboring first driving voltages, the voltage difference between each two neighboring second driving voltages is less than or equal to the reference value.

5. The source driver as claimed in claim 1, wherein the voltage difference between each two neighboring second driving voltages is the same.

6. A method for driving a display panel, the method comprising:
receiving digital image data; digital image data comprising image data of horizontal lines, the horizontal lines sequentially arranged;
storing digital image data of one horizontal line;
converting digital image data of one horizontal line to analog image data;
shifting a voltage level of analog image data, generating a number of first driving voltages, and outputting the first driving voltages to an output buffer;
calculating a voltage difference between each two neighboring first driving voltages, comparing the voltage difference with a reference value, generating a number of second driving voltages according to the reference value when the voltage difference is greater than the reference value; and outputting the second driving voltages to the output buffer; and
sequentially outputting the first driving voltages and the second driving voltages to the display panel.

7. The method as claimed in claim 6, further comprising:
generating a control signal when digital image data of one horizontal line is completely received;
storing digital image data of one horizontal line according to the control signal.

8. The method as claimed in claim 6, wherein the number of second driving voltages are between corresponding two neighboring first driving voltages, and the voltage difference between each two neighboring second driving voltages is less than or equal to the reference value.

9. The method as claimed in claim 6, wherein the voltage difference between each two neighboring second driving voltages is the same.

10. The method as claimed in claim 6, wherein the display panel is a liquid crystal display (LCD) panel.

11. A display apparatus, comprising:
a display panel; and
a source driver, the source driver comprising:
a shift register for receiving digital image data;
a latch for storing digital image data under control of the shift register;
a digital to analog converter (DAC) coupled to the latch for converting digital image data to analog image data;
an output buffer;
a level shifter coupled to the DAC for shifting a voltage level of analog image data, generating a number of first driving voltages, and outputting the first driving voltages to the output buffer; and
a comparator for calculating a voltage difference between each two neighboring first driving voltages, comparing the voltage difference with a reference value, and controlling a voltage generator to generate a number of second driving voltages according to the reference value when the voltage difference is greater than the reference value; and the voltage generator outputting the second driving voltages to the output buffer;
wherein the output buffer sequentially outputs the first driving voltages and the second driving voltages to the display panel.

12. The display apparatus as claimed in claim 11, wherein the latch sequentially receives digital image data, the digital image data comprises image data of horizontal lines, and the horizontal lines are sequentially arranged; when the shift register completely receives digital image data of one horizontal line, the shift register generates a control signal, and the latch stores digital image data of one horizontal line according to the control signal.

13. The display apparatus as claimed in claim 11, wherein the voltage generator is comprised in the source driver.

14. The display apparatus as claimed in claim 11, wherein the number of second driving voltages are between corresponding two neighboring first driving voltages, the voltage difference between each two neighboring second driving voltages is less than or equal to the reference value.

15. The display apparatus as claimed in claim 11, wherein the voltage difference between each two neighboring second driving voltages is the same.

16. The display apparatus as claimed in claim 11, wherein the display panel is a liquid crystal display (LCD) panel.
